(19) United States
(12) Patent Application Publication
(10) Pub. No.: US 2026/0312406 A1
(43) Pub. Date: Oct. 8, 2026

(54) APPARATUS AND METHOD FOR SCHEDULING UNUSED ENERGY SUPPLY FOR PLANT FACTORY BASED ON GENETIC ALGORITHM

(71) Applicant: KOREA ELECTRONICS TECHNOLOGY INSTITUTE, Seongnam-si (KR)

(72) Inventors: Min Goo LEE, Seoul (KR); Yong Kuk PARK, Seoul (KR)

(21) Appl. No.: 19/631,010

(22) Filed: Mar. 27, 2026

(30) Foreign Application Priority Data
Apr. 8, 2025 (KR) 10-2025-0045360
Apr. 8, 2025 (KR) 10-2025-0045362

(51) Int. Cl. H02J 3/00; H02J 103/30; H02J 103/50

(52) U.S. Cl. CPC H02J 3/004; H02J 2103/30; H02J 2103/50

(57) ABSTRACT

Proposed are an apparatus and method for scheduling an unused energy supply to a plant factory by using a genetic algorithm to efficiently provide unused energy, such as industrial waste heat and renewable energy, to the plant factory. The supply scheduling apparatus may improve the operational efficiency of the unused energy supply by automating the entire process, including energy demand prediction, unused energy supply amount prediction, and derivation of an optimal energy supply schedule. Furthermore, the supply scheduling apparatus can offer excellent applicability and scalability in real-world energy operating environments by flexibly responding to complex external variables, such as varying energy demand and supply characteristics depending on crop types and seasons, and fluctuating energy costs across different time slots.

### CROSS REFERENCE TO RELATED APPLICATIONS

The present application claims priority to Korean Patent Application No. 10-2025-0045360 filed on Apr. 8, 2025, and Korean Patent Application No. 10-2025-0045362 filed on Apr. 8, 2025 in the Korean Intellectual Property Office, the entire contents of which are incorporated herein for all purposes by this reference. This application is related to and concurrently filed with U.S. application (Attorney Docket No. KETHL.088AUS), entitled “APPARATUS AND METHOD FOR SCHEDULING UNUSED ENERGY SUPPLY SUPPORTING ENERGY DEMAND-SUPPLY PREDICTION FOR EACH FACILITY OF PLANT FACTORY,” the entire contents of which are incorporated herein for all purposes.

### BACKGROUND

### Technical Field

The present disclosure relates to an apparatus and method for scheduling an energy supply. More particularly, the present disclosure relates to an apparatus and method for scheduling an unused energy supply to a plant factory by using a genetic algorithm to efficiently provide unused energy, such as industrial waste heat and renewable energy, to the plant factory.

### Description of Related Technology

As climate change and abnormal weather phenomena continue to intensify, traditional open-field farming methods are significantly affected by climate risks such as rising temperatures, droughts, and floods, resulting in a decline in agricultural productivity.

### SUMMARY

One aspect is an apparatus and method for scheduling an unused energy supply for a plant factory based on a genetic algorithm to effectively allocate unused energy and establish an optimal operational strategy.

Another aspect is an apparatus for scheduling an unused energy supply to a plant factory that may include: a genetic data generation module configured to generate genetic data based on sampling data including, for a preset period, a predicted energy demand per time slot for each facility of the plant factory and a predicted unused energy supply per time slot for each unused energy source; a population generation module configured to generate an initial population formed of a plurality of individuals including the genetic data, and a population of a new generation including at least one of a plurality of child individuals; a fitness calculation module configured to calculate a fitness for each individual based on the genetic data for each individual constituting one population and energy supply costs per time slot; a parent individual selection module configured to select two or more individuals from among the plurality of individuals as parent individuals based on the fitness; a crossover/mutation module configured to generate the plurality of child individuals by performing exchange and mutation of the genetic data between the parent individuals; and an energy supply scheduling module configured to generate an optimal energy supply schedule by selecting an individual having the highest fitness from the population of each generation as an elite individual.

According to an embodiment of the present disclosure, the genetic data generation module may be configured to generate the genetic data including unused energy storage status information per time slot (es_status[t]), an unused energy supply ratio per time slot for each facility (s_factors[i,t]), and an unused energy supply amount per time slot for each facility (supply[i,t]).

According to an embodiment of the present disclosure, an initial value of the unused energy storage status information per time slot (es_status[t]^{initial}) may be generated based on the predicted unused energy supply per time slot.

According to an embodiment of the present disclosure, the initial value of the unused energy storage status information per time slot (es_status[t]^{initial}) may reflect a final value of the unused energy storage status information of a previous time slot (es_status[t−1]^{final}).

According to an embodiment of the present disclosure, the unused energy supply amount per time slot for each facility (supply[i,t]) may be a product of the initial value of the unused energy storage status information per time slot (es_status[t]^{initial}) and the unused energy supply ratio per time slot for each facility (s_factors[i,t]).

According to an embodiment of the present disclosure, for the initial population, the unused energy supply ratio per time slot for each facility (s_factors[i,t]) may be randomly set.

According to an embodiment of the present disclosure, the fitness calculation module may be configured to calculate the fitness through Equation 1 below by reflecting, as evaluation functions for the preset period: an unused energy supply cost function (fB); an unused energy final residual function (fR); an unused energy reduction rate function (fUE); a distance similarity function (fDS) between the energy supply costs per time slot and the predicted unused energy supply per time slot; a directional similarity function (fPS) between the energy supply costs per time slot and the predicted unused energy supply per time slot; and an unused energy supply-price efficiency function (fTE),

$$S = \sum {f}_{i} \cdot {A}_{i} \qquad [ Equation 1 ]$$

$${f}_{i} = [ {f}_{B} , {f}_{R} , {f}_{PS} , {f}_{DS} , {f}_{TE} , {f}_{UE} ]$$

$${A}_{i} = [ {A}_{B} , {A}_{R} , {A}_{PS} , {A}_{DS} , {A}_{TE} , {A}_{UE} ]$$

where S represents the fitness, fᵢ represents an evaluation function, and Aᵢ represents a weight for the evaluation function.

According to an embodiment of the present disclosure, the parent individual selection module may be configured to select the parent individuals using a roulette wheel selection method, in which an individual with a higher fitness has a higher probability of being selected.

According to an embodiment of the present disclosure, the crossover/mutation module may be configured to randomly exchange the unused energy supply ratio per time slot for each facility (s_factors[i,t]) between the parent individuals according to a preset crossover probability.

According to an embodiment of the present disclosure, the crossover/mutation module may be configured to randomly change the unused energy supply ratio per time slot for each facility (s_factors[i,t]) of some of the individuals subjected to the exchange, according to a preset mutation probability.

According to an embodiment of the present disclosure, when continuously generating the optimal energy supply schedule after the preset period, the genetic data generation module may be configured to generate the genetic data for a subsequent period based on an unused energy storage status for a preceding period.

Another aspect is a method for scheduling an unused energy supply to a plant factory, performed by a supply scheduling apparatus, that may include: generating genetic data based on sampling data including, for a preset period, a predicted energy demand per time slot for each facility of the plant factory and a predicted unused energy supply per time slot for each unused energy source; generating an initial population formed of a plurality of individuals including the genetic data; calculating a fitness for each individual based on the genetic data for each individual constituting one population and energy supply costs per time slot; selecting two or more individuals from among the plurality of individuals as parent individuals based on the fitness; generating a plurality of child individuals by performing exchange and mutation of the genetic data between the parent individuals; generating a population of a new generation including at least one of the plurality of child individuals; and generating an optimal energy supply schedule by selecting an individual having the highest fitness from the population of each generation as an elite individual.

According to an embodiment of the present disclosure, in the generating of the genetic data, when continuously generating the optimal energy supply schedule after the preset period, the genetic data for a subsequent period may be generated based on an unused energy storage status for a preceding period.

The supply scheduling apparatus according to the present disclosure can improve the operational efficiency of unused energy supply by automating the entire process, including energy demand prediction, unused energy supply prediction, and derivation of an optimal energy supply schedule for a plant factory.

Furthermore, the supply scheduling apparatus according to the present disclosure can offer excellent applicability and scalability in real-world energy operating environments by flexibly responding to complex external variables, such as varying energy demand and supply characteristics depending on crop types and seasons, and fluctuating energy costs across different time slots.

### BRIEF DESCRIPTION OF THE DRAWINGS

FIG. 1 is a block diagram illustrating a supply scheduling apparatus according to an embodiment.

FIG. 2 is a view illustrating an example of a training process of a prediction model unit according to an embodiment.

FIG. 3 is a graph illustrating an example of sampling data generated by a prediction model unit according to an embodiment.

FIGS. 4A and 4B are views illustrating a connection relationship between a prediction model unit and a scheduling model unit according to an embodiment.

FIG. 5 is a graph illustrating genetic data generated by a genetic data generation module according to an embodiment.

FIG. 6 is a flowchart illustrating relationships between genetic data of a supply scheduling apparatus according to an embodiment.

FIG. 7 is a graph illustrating genetic data of individuals constituting an initial population generated by a population generation module according to an embodiment.

FIG. 8 is a graph illustrating an example of energy supply costs per time slot.

FIG. 9 is a graph illustrating an energy supply pattern of an individual evaluated by an unused energy supply cost function (f_{B}) in a supply scheduling apparatus according to an embodiment.

FIG. 10 is a graph illustrating an energy supply pattern of an individual evaluated by an unused energy reduction rate function (f_{UE}) and an unused energy final residual function (f_{R}) in a supply scheduling apparatus according to an embodiment.

FIG. 11 is a graph illustrating an energy supply pattern of an individual evaluated by a distance similarity function (f_{DS}), a directional similarity function (f_{PS}), and an unused energy supply-price efficiency function (f_{TE}) in a supply scheduling apparatus according to an embodiment.

FIG. 12 is a graph illustrating energy supply patterns of parent individuals and child individuals generated through crossover between the parent individuals according to an embodiment.

FIG. 13 is a graph illustrating energy supply patterns of an individual subjected to crossover and a child individual generated by performing mutation on genetic data of the individual according to an embodiment.

FIG. 14 is a graph illustrating energy supply patterns of individuals for each population of a new generation generated by a population generation module according to an embodiment.

FIG. 15 is a graph illustrating an energy supply pattern representing an optimal energy supply schedule generated by a scheduling model unit according to an embodiment.

FIG. 16 is a flowchart illustrating a method for scheduling unused energy supply according to an embodiment.

FIG. 17 is a flowchart illustrating an optimal energy supply scheduling step of a method for scheduling unused energy supply according to an embodiment.

### DETAILED DESCRIPTION

Plant factories, which enable stable production of high-quality crops by artificially controlling growth environments, are attracting attention. However, plant factories require various environmental control systems, such as lighting, HVAC (heating, ventilation, and air conditioning), and carbon dioxide concentration control, and thus high energy consumption acts as a major disadvantage. In particular, as plant factories become larger and more automated, the proportion of energy costs in operating expenses increases, leading to a growing economic burden.

To address this, the utilization of unused energy, including industrial waste heat and renewable energy, has been proposed. Unused energy refers to energy sources that are currently discarded without being utilized, including waste heat generated from industrial processes, exhaust gases discharged from factories, and surplus power from renewable energy. By integrating such unused energy into a plant factory system, energy consumption issues can be alleviated. In this regard, energy supply scheduling, which establishes an optimal energy use plan by considering the variability of production and demand for each energy source, is essential.

Accordingly, there is a need for research on energy supply scheduling to effectively distribute unused energy available in plant factories and to establish optimal operational strategies.

In the following description and drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to their common or dictionary meanings and are merely used by the inventor to enable a clear and consistent understanding of the disclosure. Thus, it will be apparent to those skilled in the art that the description about various embodiments of the present disclosure is provided for illustration purpose only and not for the purpose of limiting the disclosure as defined by the appended claims and their equivalents.

The terms such as “unit” and “module” used herein refer to a unit that processes at least one function or operation and may be implemented with hardware, software, or a combination of hardware and software. In addition, the terms “a”, “an”, “one”, “the”, and similar terms are used herein in the context of describing the present disclosure (especially in the context of the following claims) may be interpreted as including both singular and plural meanings unless the context clearly indicates otherwise.

Now, embodiments of the present disclosure will be described in detail with reference to the accompanying drawings.

Plant factories enable stable production of high-quality crops by artificially controlling growth environments. However, they require various environmental control systems, such as lighting, HVAC (heating, ventilation, and air conditioning), and carbon dioxide concentration control, which result in high energy costs as a significant operational disadvantage.

The present disclosure aims to address such energy consumption issues by utilizing unused energy in plant factories.

The unused energy refers to energy sources currently discarded without being utilized, including waste heat from industrial processes, exhaust gases from factories, and surplus power from renewable energy. Since unused energy has high variability in production and demand, energy demand prediction and energy supply scheduling per time slot are essential for the stable operation of plant factories.

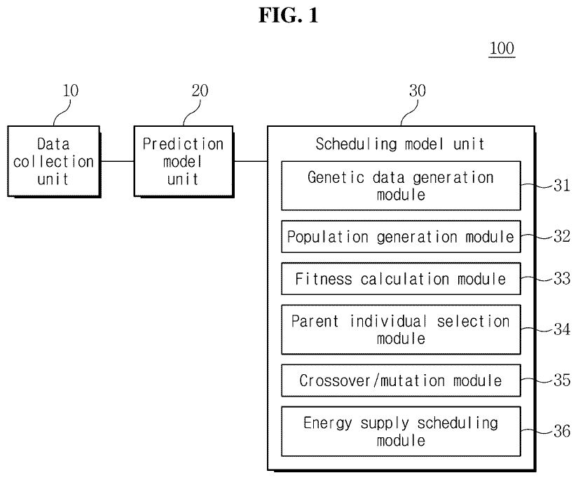

FIG. 1 is a block diagram illustrating a supply scheduling apparatus according to an embodiment.

Referring to FIG. 1, the supply scheduling apparatus 100 according to an embodiment includes a data collection unit 10, a prediction model unit 20, and a scheduling model unit 30.

Specifically, the data collection unit 10 generates time-series data by measuring energy consumption for each facility of a plant factory and the amount of unused energy supplied to the plant factory from each unused energy source. The prediction model unit 20 generates sampling data from the time-series data. The sampling data includes a predicted energy demand per time slot for each facility and a predicted unused energy supply per time slot for a preset period. The scheduling model unit 30 generates an optimal energy supply schedule for the preset period based on a genetic algorithm using the sampling data and energy supply costs per time slot.

Hereinafter, the configuration of the supply scheduling apparatus 100 according to an embodiment will be described in more detail.

The data collection unit 10 may measure energy consumption for each facility from energy consumption measurement sensors respectively installed in facilities, such as lighting devices and HVAC units, existing within the plant factory. Additionally, the data collection unit 10 may measure an unused energy supply amount provided by an unused energy source to the plant factory, from an energy supply measurement sensor installed at the unused energy source.

The data collection unit 10 may measure the energy consumption for each facility and the unused energy supply amount in real-time, and generate time-series data by recording the measured data at regular intervals (e.g., 10 minutes, 30 minutes, 1 hour, etc.) for a preset period (e.g., 24 hours). In this case, it is preferable that the time-series data has a measurement unit of 60 minutes or less.

The prediction model unit 20 may generate, from the time-series data, sampling data including, for a preset period, a predicted energy demand per time slot for each facility and a predicted unused energy supply per time slot.

The prediction model unit 20 may be implemented as a deep learning model based on Long Short-Term Memory (LSTM). Specifically, the prediction model unit 20 may include three primary layers. A first layer may process the time-series data input at each time step and generate output values for the energy consumption and the unused energy supply at a specific point in time. A second layer may analyze overall energy consumption and energy supply patterns by aggregating the output values per time step generated by the first layer and generate summarized information. In this process, the prediction model unit 20 may reflect key features of the data over time to derive more accurate results. A third layer may generate the sampling data including, for a preset period, the predicted energy demand per time slot for each facility and the predicted unused energy supply per time slot, based on the summarized information from the second layer.

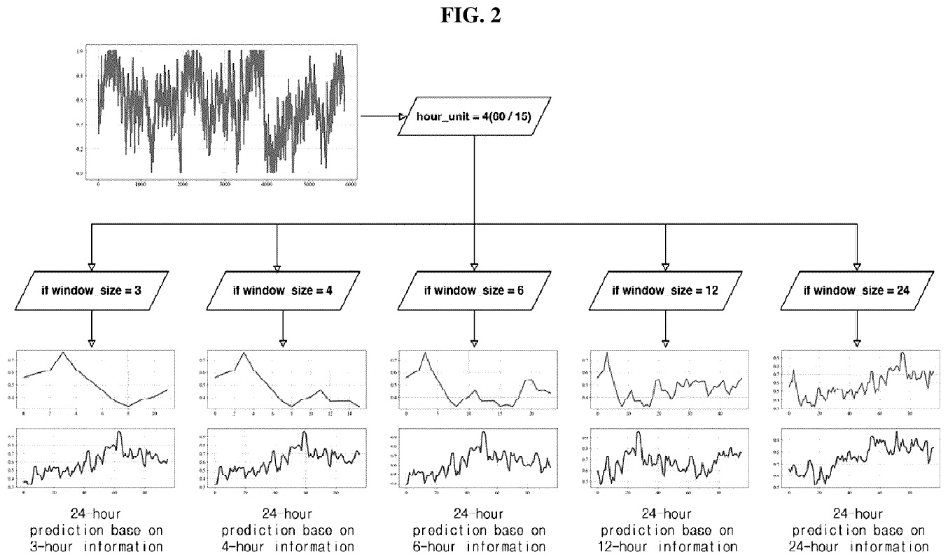

FIG. 2 is a view illustrating an example of a training process of a prediction model unit according to an embodiment.

Referring to FIG. 2, the prediction model unit 20 may be trained using a sliding window method on the input time-series data. The sliding window method is a technique for training by moving a window of a fixed size at regular intervals within the time-series data, enabling the prediction model unit 20 to predict the future based on past data. An “hour unit” is a variable representing how a one-hour unit of the input time-series data is to be divided. For example, if the hour unit is 6, the time-series data may be divided into 10-minute intervals (60 minutes/6); and if the hour unit is 4, the time-series data may be divided into 15-minute intervals (60 minutes/4). A “window size” represents the length of data used as a single input during the training of the prediction model. For example, when the hour unit is 4 and the window size is 3, the prediction model unit 20 may use the time-series data, which is divided into 15-minute intervals, as an input while sliding the data over a 3-hour length. The training may be performed in a manner of generating sampling data that includes a predicted energy demand per time slot for each facility and a predicted unused energy supply per time slot for the subsequent 24 hours in response to each input.

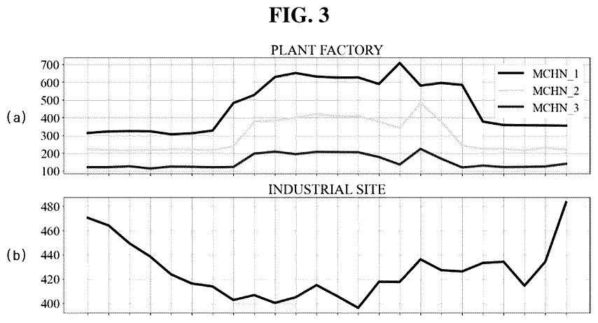

FIG. 3 is a graph illustrating an example of sampling data generated by a prediction model unit according to an embodiment.

As shown in (a) of FIG. 3, the sampling data includes a predicted energy demand per time slot for each facility of the plant factory. As shown in (b) of FIG. 3, the sampling data may include a predicted unused energy supply per time slot for an unused energy source.

Generally, energy consumption and supply patterns vary significantly depending on environmental conditions. For example, during the summer, cooling usage in a plant factory is high, leading to a substantial increase in energy consumption during daytime hours. In contrast, during the winter, heating usage is high, which may result in a substantial increase in energy consumption during nighttime hours. Accordingly, if a prediction model is trained regardless of environmental conditions, the model may fail to distinguish between energy consumption patterns of the summer and the winter.

Therefore, the prediction model unit 20 may generate sampling data optimized for the environment by training on time-series data, which records the energy consumption for each facility and the unused energy supply amount, according to environmental conditions including season, weather, and temperature.

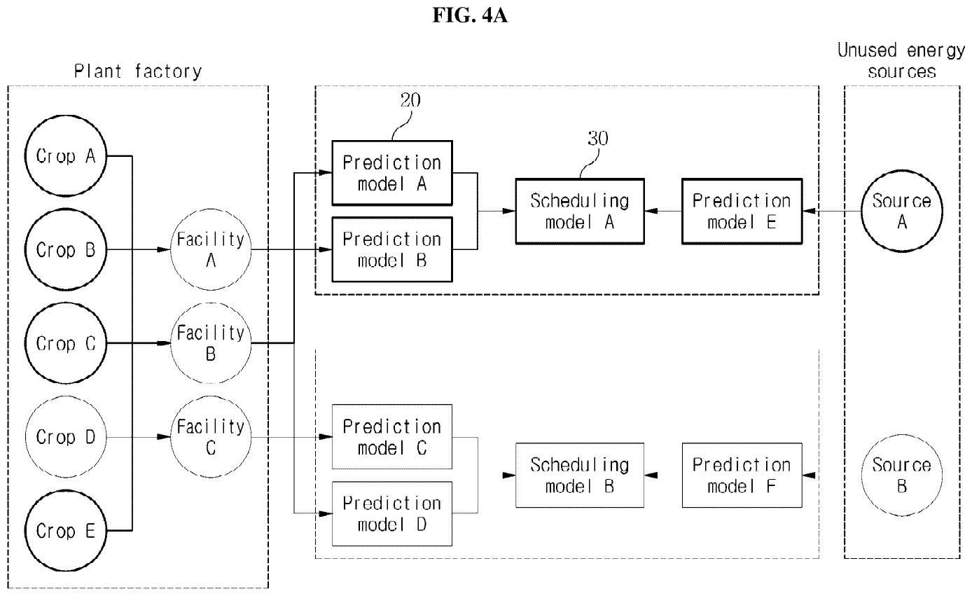

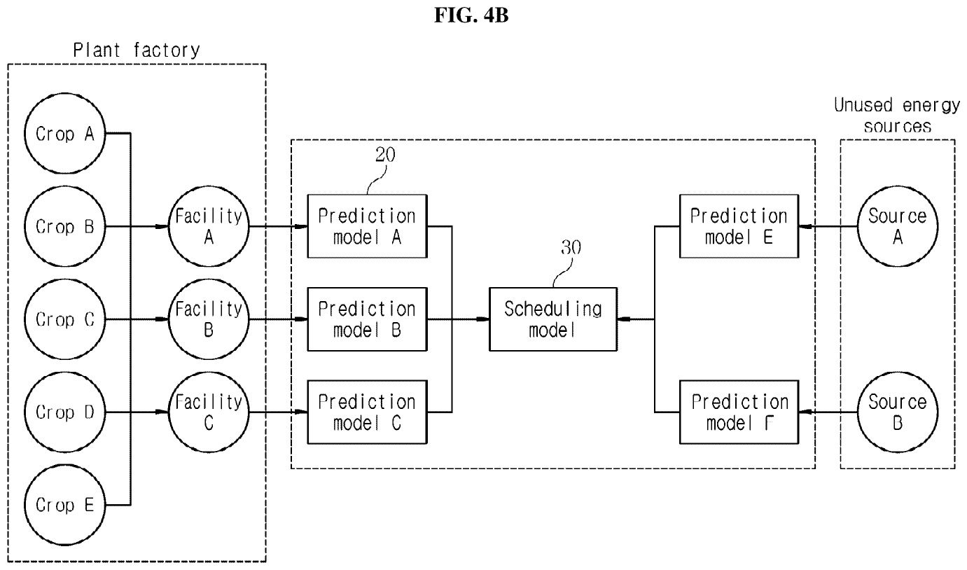

FIGS. 4A and 4B are views illustrating a connection relationship between a prediction model unit and a scheduling model unit according to an embodiment.

Referring to FIGS. 4A and 4B, the prediction model unit 20 may include a plurality of prediction models individually disposed for each facility of a plant factory or for each unused energy source. Each prediction model may generate individual training and sampling data for each node. In this case, a plurality of crops grown in the plant factory may be independently mapped to a single facility or multi-mapped to a plurality of facilities. Furthermore, each facility and each unused energy source may also be multi-mapped to a plurality of prediction models to perform complex operations. The prediction model unit 20 operates independently without being directly connected to the scheduling model unit 30, yet may indirectly interact with the scheduling model unit 30 through the sampling data. That is, the sampling data generated by the prediction model unit 20 may be changed according to the crops and unused energy sources to be reflected in scheduling, and such sampling data may affect the optimal energy supply schedule generated by the scheduling model unit 30.

For example, as shown in FIG. 4A, when crops A, B, C, and E and unused energy source A are included as scheduling targets, facilities A and B multi-mapped with crops A, B, C, and E are connected to prediction models A and B, and unused energy source A is connected to prediction model E. Accordingly, prediction models A, B, and E independently calculate sampling data for their respective targets, and these sampling data are transmitted to scheduling model A to generate an optimal energy supply schedule.

Alternatively, as shown in FIG. 4B, when all crops and all unused energy sources are included as scheduling targets, sampling data for all prediction models multi-mapped thereto are independently calculated, and the scheduling model may integrate these to generate an optimal energy supply schedule.

The scheduling model unit 30 is based on a genetic algorithm and may generate an optimal energy supply schedule for a preset period from the sampling data and the energy supply costs per time slot. For example, the scheduling model unit 30 may generate an optimal energy supply schedule for the future 24 hours.

Specifically, the scheduling model unit 30 may include, as shown in FIG. 1, a genetic data generation module (or a genetic data generation processor) 31, a population generation module (or a population generation processor) 32, a fitness calculation module (or a fitness calculation processor) 33, a parent individual selection module (or a parent individual selection processor) 34, a crossover/mutation module (or a crossover/mutation processor) 35, and an energy supply scheduling module (or an energy supply scheduling processor) 36.

The genetic data generation module 31 may generate genetic data based on the sampling data.

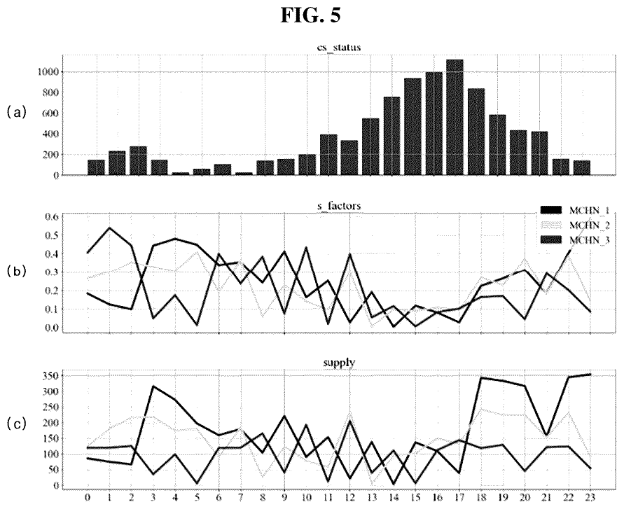

FIG. 5 is a graph illustrating genetic data generated by a genetic data generation module according to an embodiment.

Specifically, in FIG. 5, (a) is a graph illustrating unused energy storage status information per time slot (es_status[t]), (b) is a graph illustrating an unused energy supply ratio per time slot for each facility (s_factors[i,t]), and (c) is a graph illustrating an unused energy supply amount per time slot for each facility (supply[i,t]).

The genetic data may include the unused energy storage status information per time slot (es_status[t]), the unused energy supply ratio per time slot for each facility (s_factors[i,t]), and the unused energy supply amount per time slot for each facility (supply[i,t]).

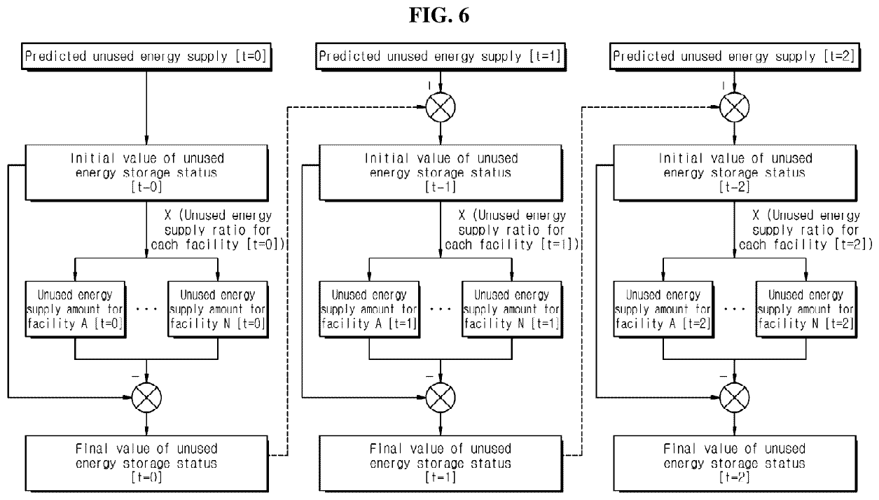

FIG. 6 is a flowchart illustrating relationships between genetic data of a supply scheduling apparatus according to an embodiment.

Referring to FIG. 6, the unused energy storage status information per time slot (es_status[t]) represents a storage state of unused energy stored in an energy storage system (ESS) of a plant factory. An initial value of the unused energy storage status information per time slot (es_status[t]^{initial}) may be generated based on the predicted unused energy supply per time slot generated by the prediction model unit 20.

In particular, the initial value of the unused energy storage status information per time slot (es_status[t]^{initial}) may reflect a final value of the unused energy storage status information of the previous time slot (es_status[t−1]^{final}). In this case, the final value of the unused energy storage status information per time slot (es_status[t]^{final}) may be set as a value obtained by subtracting the unused energy supply amount per time slot for each facility (supply[i,t]) from the initial value of the unused energy storage status information per time slot (es_status[t]^{initial}).

That is, the unused energy storage status information per time slot (es_status[t]) may continuously reflect the unused energy storage status information of the previous time slot (es_status[t−1]), thereby allowing for the continuous management of the storage state of the unused energy.

The unused energy supply amount per time slot for each facility (supply[i,t]) refers to the amount of unused energy supplied to each facility, and can be represented as a product of the initial value of the unused energy storage status information per time slot (es_status[t]^{initial}) and the unused energy supply ratio per time slot for each facility (s_factors[i,t]).

In this case, for an initial population, the unused energy supply ratio per time slot for each facility (s_factors[i,t]) may be randomly set within a range where the total sum is 100% or less. For populations of new generations after the initial population, the unused energy supply ratio per time slot for each facility (s_factors[i,t]) may be set through crossover and mutation.

FIG. 7 is a graph illustrating genetic data of individuals constituting an initial population generated by a population generation module according to an embodiment.

Referring to FIG. 7, the population generation module 32 may generate an initial population formed of a plurality of individuals including genetic data. In addition, the population generation module 32 may generate a population of a new generation, which will be described later.

The population generation module 32 may set a population size representing the number of individuals constituting a population of one generation. If the population size is too small, genetic diversity within the population may be insufficient, limiting the search range and increasing the likelihood of falling into a local optimum, thereby making it difficult to find an optimal solution. Conversely, if the population size is too large, the amount of calculation increases, which raises the computational burden for fitness evaluation, crossover, and mutation, potentially slowing down the learning speed. Accordingly, the population generation module 32 may set the population size to a range of 20 to 100, and preferably to 50.

The fitness calculation module 33 may calculate a fitness for each individual based on the genetic data for each individual in the population and the energy supply costs per time slot. The fitness serves as a criterion for evaluating the performance of an individual and may determine a search direction in the process of the genetic algorithm finding an optimal solution. For example, the fitness calculation module 33 may calculate the fitness in a search direction that reduces the supply price of unused energy, ensures the energy supply pattern follows the energy consumption pattern, and encourages a higher supply during time slots when the supply price of unused energy is low.

Specifically, the fitness calculation module 33 may calculate the fitness by reflecting, as evaluation functions for a preset period: a supply cost function (f_{B}); an unused energy final residual function (f_{R}); an unused energy reduction rate function (f_{UE}); a distance similarity function (f_{DS}) between the energy supply costs per time slot and the predicted unused energy supply per time slot; a directional similarity function (f_{PS}) between the energy supply costs per time slot and the predicted unused energy supply per time slot; and an unused energy supply-price efficiency function (f_{TE}).

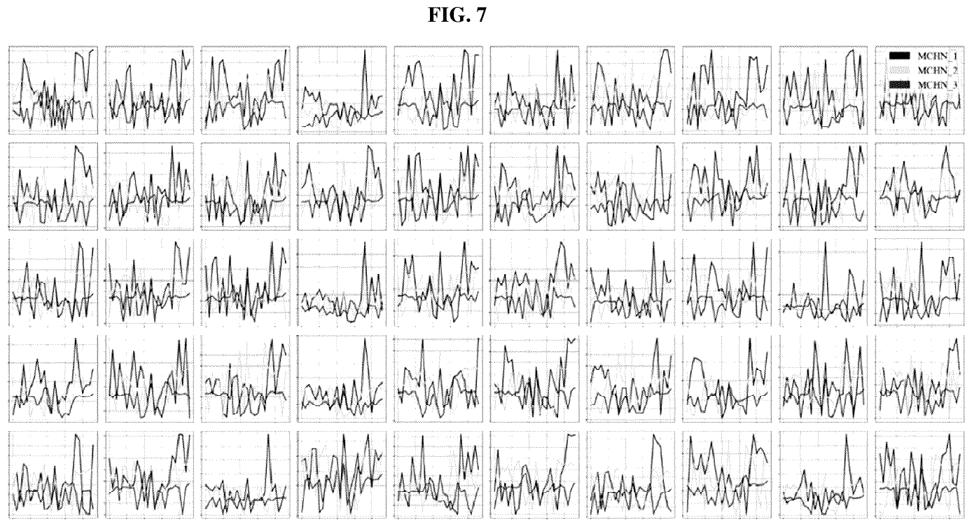

FIG. 8 is a graph illustrating an example of energy supply costs per time slot.

Referring to FIG. 8, the energy supply costs per time slot may be defined based on a time-of-use (TOU) pricing system. The price per unit energy may be set high during time slots with high energy demand, and low during time slots with low energy demand throughout a day.

The unused energy supply cost function (f_{B}) is a function for evaluating a total unused energy supply cost, which is derived by multiplying the unused energy supply amount per time slot for each facility (supply[i,t]) by the energy supply costs per time slot. The function may be designed such that a lower total unused energy supply cost results in a higher score. Accordingly, the unused energy supply cost function (f_{B}) may guide the search of the genetic algorithm in a direction that reduces the supply price of the unused energy.

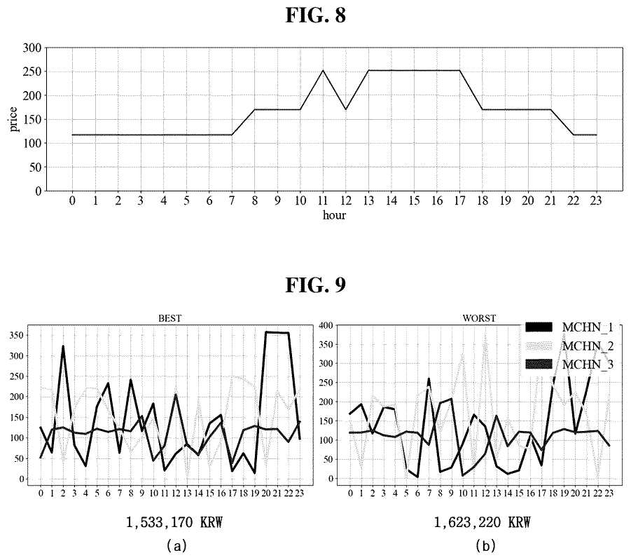

FIG. 9 is a graph illustrating an energy supply pattern of an individual evaluated by an unused energy supply cost function (f_{B}) in a supply scheduling apparatus according to an embodiment. Specifically, in FIG. 9, (a) is a graph illustrating an energy supply pattern of an individual having the highest value of the unused energy supply cost function (f_{B}), and (b) is a graph illustrating an energy supply pattern of an individual having the lowest value of the unused energy supply cost function (f_{B}).

The individual shown in (a) of FIG. 9 has a total unused energy supply cost of 1,533,170 KRW, which is the lowest supply cost within the corresponding population. The individual shown in (b) of FIG. 9 has a total unused energy supply cost of 1,623,220 KRW, which is the highest supply cost within the corresponding population. Since the unused energy supply cost function (f_{B}) is designed to assign a higher score as the total unused energy supply cost decreases, the individual with the total unused energy supply cost of 1,533,170 KRW may generate the highest value for the unused energy supply cost function (f_{B}).

The unused energy reduction rate function (f_{UE}) is a function for evaluating a reduction rate of unused energy use relative to a predicted energy demand per time slot for each facility among the sampling data. The function may be designed such that a higher reduction rate of unused energy use results in a higher score.

The unused energy final residual function (f_{R}) is a function for evaluating a residual amount of unused energy remaining after supplying energy to each facility for a preset period. The function may be designed such that a lower residual amount results in a higher score.

That is, the unused energy reduction rate function (f_{UE}) and the unused energy final residual function (f_{R}) can prevent an individual, whose overall unused energy supply amount is close to zero for cost reduction purposes, from receiving a high score in the unused energy supply cost function (f_{B}) and being searched as an individual with high fitness. Through this, it is possible to guide the search toward an energy supply pattern that is similar to the energy consumption pattern of the plant factory, in addition to reducing unused energy costs.

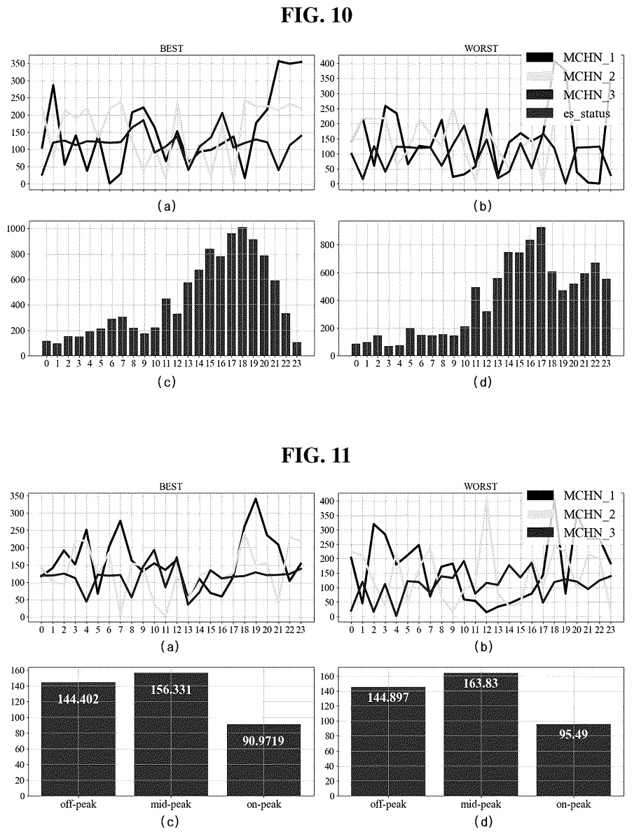

FIG. 10 is a graph illustrating an energy supply pattern of an individual evaluated by an unused energy reduction rate function (f_{UE}) and an unused energy final residual function (f_{R}) in a supply scheduling apparatus according to an embodiment. Specifically, in FIG. 10, (a) is a graph illustrating an energy supply pattern of an individual having the highest values for the unused energy reduction rate function (f_{UE}) and the unused energy final residual function (f_{R}), and (b) is a graph illustrating an energy supply pattern of an individual having the lowest values for the unused energy reduction rate function (f_{UE}) and the unused energy final residual function (f_{R}). Additionally, in FIG. 10, (c) is a graph illustrating unused energy storage status information per time slot (es_status[t]) of the individual shown in (a), and (d) is a graph illustrating unused energy storage status information per time slot (es_status[t]) of the individual shown in (b).

The individual shown in (a) of FIG. 10 may receive a lower score in the unused energy supply cost function (f_{B}) compared to the individual shown in (a) of FIG. 9; however, by obtaining higher scores in the unused energy reduction rate function (f_{UE}) and the unused energy final residual function (f_{R}), the individual may exhibit an energy supply pattern similar to the energy consumption pattern of the plant factory.

The distance similarity function (f_{DS}) is a function for evaluating a distance similarity between energy supply costs per time slot and a predicted unused energy supply per time slot. The function may be designed such that a higher distance similarity results in a higher score. The directional similarity function (f_{PS}) is a function for evaluating a directional similarity between the energy supply costs per time slot and the predicted unused energy supply per time slot. The function may be designed such that a higher directional similarity results in a higher score. The unused energy supply-price efficiency function (f_{TE}) may be designed such that a higher score is assigned as more supply is provided during time slots when the supply price of unused energy is low. That is, the distance similarity function (f_{DS}), the directional similarity function (f_{PS}), and the unused energy supply-price efficiency function (f_{TE}) may guide the search toward an individual that provides more supply during time slots when the supply price of unused energy is low.

FIG. 11 is a graph illustrating an energy supply pattern of an individual evaluated by a distance similarity function (f_{DS}), a directional similarity function (f_{PS}), and an unused energy supply-price efficiency function (f_{TE}) in a supply scheduling apparatus according to an embodiment. Specifically, in FIG. 11, (a) is a graph illustrating an energy supply pattern of an individual having the highest values for the distance similarity function (f_{PS}), the directional similarity function (f_{PS}), and the unused energy supply-price efficiency function (f_{TE}), and (b) is a graph illustrating an energy supply pattern of an individual having the lowest values for the distance similarity function (f_{DS}), the directional similarity function (f_{DS}), and the unused energy supply-price efficiency function (f_{TE}). Additionally, in FIG. 11, (c) is a graph illustrating an average supply amount per load for each time slot of the individual shown in (a), and (d) is a graph illustrating an average supply amount per load for each time slot of the individual shown in (b).

Comparing (c) and (d) in FIG. 11, while the average values of unused energy supplied during off-peak loads are similar, the average values of unused energy supplied during mid-peak and on-peak loads are lower in (c). As shown in FIG. 8, since the energy supply cost per time slot is higher during high-load time slots, an individual having lower average values for unused energy supplied during mid-peak and on-peak loads may receive higher scores in the distance similarity function (f_{DS}), the directional similarity function (f_{PS}), and the unused energy supply-price efficiency function (f_{TE}).

The fitness calculation module 33 may set a weight for each evaluation function and calculate the fitness by summing the products of each evaluation function and its weight as shown in Equation 1 below.

$$S = \sum {f}_{i} \cdot {A}_{i} \qquad [ Equation 1 ]$$

$${f}_{i} = [ {f}_{B} , {f}_{R} , {f}_{PS} , {f}_{DS} , {f}_{TE} , {f}_{UE} ]$$

$${A}_{i} = [ {A}_{B} , {A}_{R} , {A}_{PS} , {A}_{DS} , {A}_{TE} , {A}_{UE} ]$$

Here, S represents the fitness, fᵢ represents an evaluation function, and Aᵢ represents a weight for the evaluation function.

The parent individual selection module 34 may select two or more individuals from among a plurality of individuals as parent individuals based on the fitness. Specifically, the parent individual selection module 34 may select the parent individuals using a roulette wheel selection method, in which an individual with a higher fitness has a higher probability of being selected. In a genetic algorithm, for a population to evolve, individuals with high fitness must pass their genetic data to the next generation. However, if only the individuals with the highest fitness are selected as parent individuals, there is a risk that the population will prematurely converge to a specific solution and become trapped in a local optimum. Accordingly, the parent individual selection module 34 may maintain the genetic diversity of the individuals while rapidly searching for an optimal solution through the roulette wheel selection method.

The crossover/mutation module 35 may generate a plurality of child individuals by performing exchange and mutation of genetic data between the parent individuals. The crossover/mutation module 35 may expand a search space by generating new child individuals while inheriting the genetic characteristics of the parent individuals.

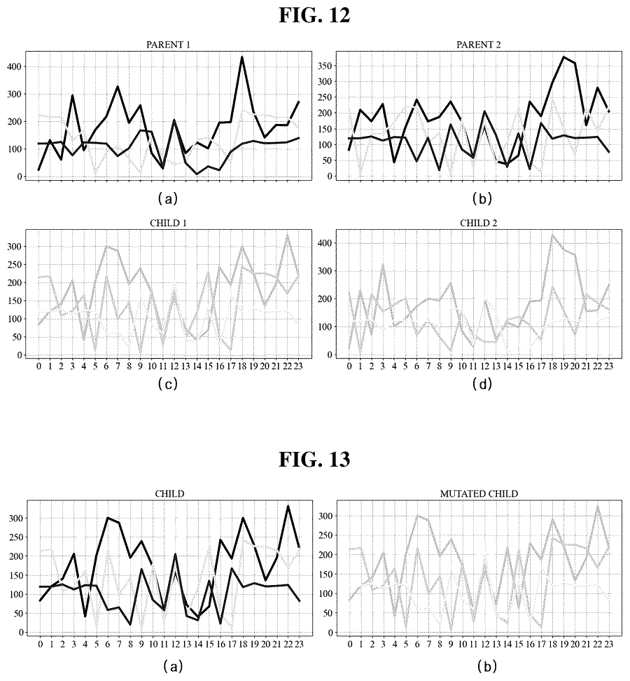

FIG. 12 is a graph illustrating energy supply patterns of parent individuals and child individuals generated through crossover between the parent individuals according to an embodiment. Specifically, in FIG. 12, (a) and (b) are graphs illustrating the energy supply patterns of the parent individuals, and (c) and (d) are graphs illustrating the energy supply patterns of the child individuals generated through crossover between the parent individuals.

The crossover/mutation module 35 may randomly exchange the unused energy supply ratio per time slot for each facility (s_factors[i,t]) between the parent individuals according to a preset crossover probability. For example, the crossover/mutation module 35 may generate a random number between 0 and 1; it may perform the crossover if the random number is greater than or equal to the preset crossover probability, and may not perform the crossover if the random number is less than the crossover probability.

Among the genetic data constituting an individual, the unused energy supply amount per time slot for each facility (supply[i,t]) depends on the unused energy storage status information per time slot (es_status[t]) and the unused energy supply ratio per time slot for each facility (s_factors[i,t]). Accordingly, if the crossover/mutation module 35 were to exchange the unused energy supply amount per time slot for each facility (supply[i,t]) itself, additional calculations would be required, and subsequent operations to correct imbalances in the overall unused energy supply schedule could increase.

On the other hand, when the crossover/mutation module 35 exchanges the unused energy supply ratio per time slot for each facility (s_factors[i,t]), the unused energy supply amount per time slot for each facility (supply[i,t]) is automatically adjusted based on the unused energy storage status information per time slot (es_status[t]). Therefore, compared to directly exchanging the unused energy supply amount (supply[i,t]), the computational complexity can be effectively reduced. This may contribute to improving the search speed of the genetic algorithm.

FIG. 13 is a graph illustrating energy supply patterns of an individual subjected to crossover and a child individual generated by performing mutation on genetic data of the individual according to an embodiment. Specifically, in FIG. 13, (a) is a graph illustrating an energy supply pattern of an individual subjected to crossover, and (b) is a graph illustrating an energy supply pattern of a child individual generated by performing mutation on the genetic data of the individual shown in (a).

The crossover/mutation module 35 may randomly change the unused energy supply ratio per time slot for each facility (s_factors[i,t]) of some of the individuals subjected to exchange, according to a preset mutation probability. In a genetic algorithm, performing only crossover operations may cause individuals to converge quickly to a specific solution; however, a problem of becoming trapped in a local optimum may occur due to a lack of diversity in the search space. To prevent this, the crossover/mutation module 35 may provide a new search space by performing mutation on the unused energy supply ratio per time slot for each facility (s_factors[i,t]). For example, the crossover/mutation module 35 may generate a random number between 0 and 1; it may perform the mutation if the random number is greater than or equal to a preset mutation probability, and may not perform the mutation if the random number is less than the mutation probability. At this time, the crossover/mutation module 35 may perform correction such that the total sum of the unused energy supply ratios per time slot for each facility (s_factors[i,t]) is 100% or less.

The population generation module 32 may generate a population of a new generation including at least one of the child individuals generated through crossover and mutation. For example, the population generation module 32 may generate the population of the new generation through any one of a total replacement method, a partial replacement method, or an elite replacement method, depending on the purpose.

The total replacement method is a method of configuring a new generation only with child individuals by removing all individuals of a population constituting a previous generation, i.e., parent individuals. While this method can secure a new search space, there is a risk of losing superior parent individuals.

The partial replacement method is a method of replacing low-fitness parent individuals with child individuals while maintaining some parent individuals. This allows for new exploration while maintaining existing superior individuals, but there is a problem that the new search range is reduced. The partial replacement method generally replaces 20% to 50% of parent individuals in one generation, but is not limited thereto.

The elite replacement method is a method of maintaining some parent individuals with high fitness and replacing the rest with child individuals. This ensures an optimal solution and allows for fast convergence, but there is a risk of falling into a local optimum due to reduced genetic diversity. The elite replacement method generally replaces 80% to 90% of parent individuals in one generation, but is not limited thereto.

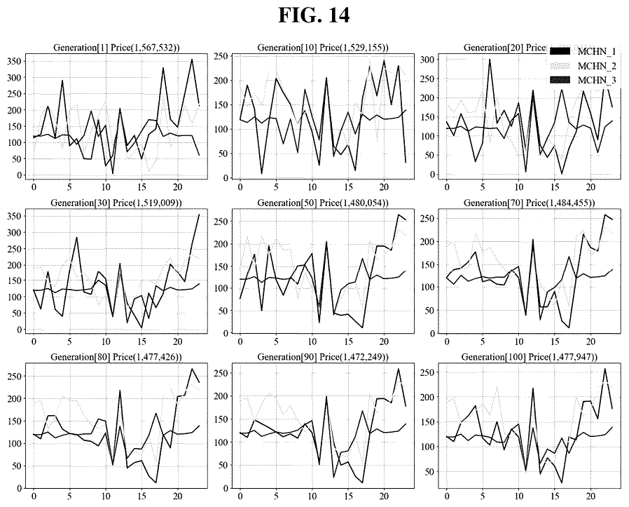

FIG. 14 is a graph illustrating energy supply patterns of individuals for each population of a new generation generated by a population generation module according to an embodiment.

Referring to FIG. 14, the population generation module 32 may generate populations of several generations by determining a generation size variable, which determines how many times the genetic algorithm is to be repeated. If the generation size variable is small, the number of repetitions of the genetic algorithm is small, resulting in a low amount of calculation and a fast execution speed; however, it may be difficult to find an optimal solution because a sufficient number of generations are not generated. If the generation size variable is large, the search space expands and a better optimal solution can be explored, but the amount of calculation increases and the convergence speed may slow down. Accordingly, the population generation module 32 may freely select the generation size variable depending on the purpose; for example, the population generation module 32 may set the generation size variable to 100.

The energy supply scheduling module 36 may select an individual having the highest fitness from the population of each generation as an elite individual, and may generate an optimal energy supply schedule based on the genetic data of the elite individual.

Furthermore, when continuously generating an optimal energy supply schedule after a preset period, the scheduling model unit 30 may generate an optimal energy supply schedule for a subsequent period based on the unused energy storage status for a preceding period.

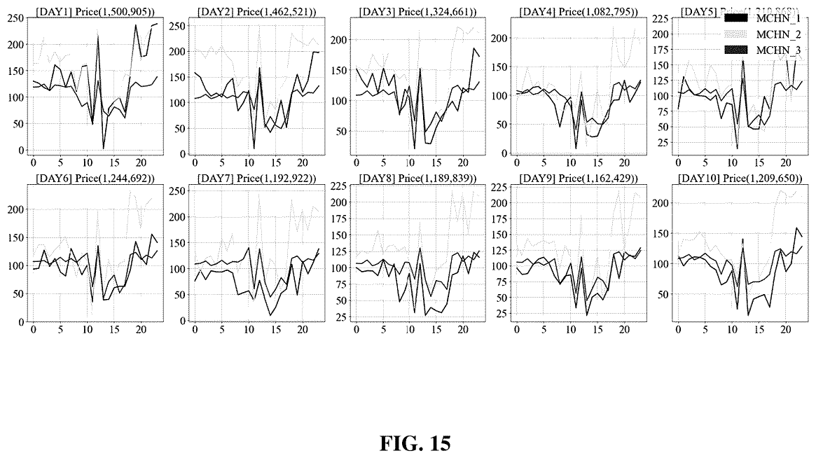

FIG. 15 is a graph illustrating an energy supply pattern representing an optimal energy supply schedule generated by a scheduling model unit according to an embodiment.

Referring to FIG. 15, when generating an optimal energy supply schedule for a second day after generating an optimal energy supply schedule for a first day, the scheduling model unit 30 according to the embodiment may derive the optimal energy supply schedule by reflecting a final value of unused energy storage status information of the first day (es_status^{final}) into an initial value of unused energy storage status information of the second day (es_status^{initial}). Through this, the supply scheduling apparatus 100 according to the embodiment may continuously optimize the supply schedule in a continuous time flow and perform more stable and efficient scheduling.

As described above, the supply scheduling apparatus 100 according to the embodiment may automate the entire process, from energy demand prediction for supplying unused energy to a plant factory, to unused energy supply amount prediction, and to derivation of an optimal energy supply schedule, thereby improving the operational efficiency of unused energy supply.

In addition, the supply scheduling apparatus 100 according to the embodiment flexibly responds to the variability of complex external variables, such as energy demand and supply characteristics that vary by crop type and season, and energy usage costs that change per time slot. Thus, the apparatus exhibits excellent applicability and scalability in actual energy operation environments.

Hereinafter, an unused energy supply scheduling method according to an embodiment will be described in more detail.

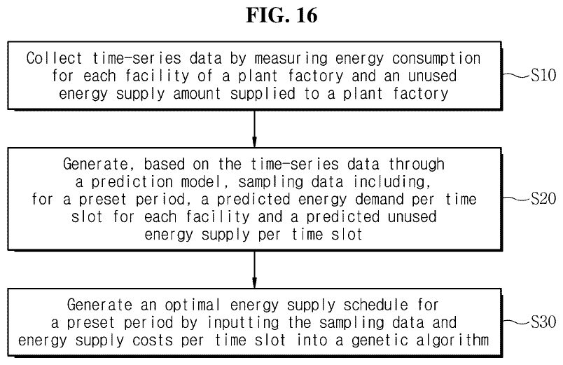

FIG. 16 is a flowchart illustrating a method for scheduling unused energy supply according to an embodiment.

Referring to FIG. 16, first, in step S10, a supply scheduling apparatus collects time-series data by measuring energy consumption for each facility of a plant factory and an unused energy supply amount supplied to the plant factory.

The supply scheduling apparatus may measure the energy consumption for each facility from energy consumption measurement sensors respectively installed in facilities, such as lighting devices and HVAC units, existing within the plant factory. Additionally, the apparatus may measure the unused energy supply amount provided by an unused energy source to the plant factory, from an energy supply measurement sensor installed at the unused energy source. In this case, the supply scheduling apparatus may measure the energy consumption for each facility and the unused energy supply amount in real-time, and generate time-series data by recording the energy consumption for each facility and the unused energy supply amount at regular intervals (e.g., 10 minutes, 30 minutes, 1 hour, etc.) for a preset time (e.g., 24 hours). At this time, it is preferable that the time-series data has a measurement unit of 60 minutes or less.

Next, in step S20, the supply scheduling apparatus generates, based on the time-series data through a prediction model, sampling data including, for a preset period, a predicted energy demand per time slot for each facility and a predicted unused energy supply per time slot.

Here, the prediction model may be implemented as a deep learning model based on Long Short-Term Memory (LSTM), and may be trained on the input time-series data using a sliding window method. In this case, the prediction model may generate sampling data optimized for the environment by training on the time-series data, which records the energy consumption for each facility and the unused energy supply amount, according to environmental conditions including season, weather, and temperature.

Finally, in step S30, the supply scheduling apparatus generates an optimal energy supply schedule for a preset period by inputting the sampling data and energy supply costs per time slot into a genetic algorithm.

Hereinafter, step S30 of generating the optimal energy supply schedule will be described in more detail.

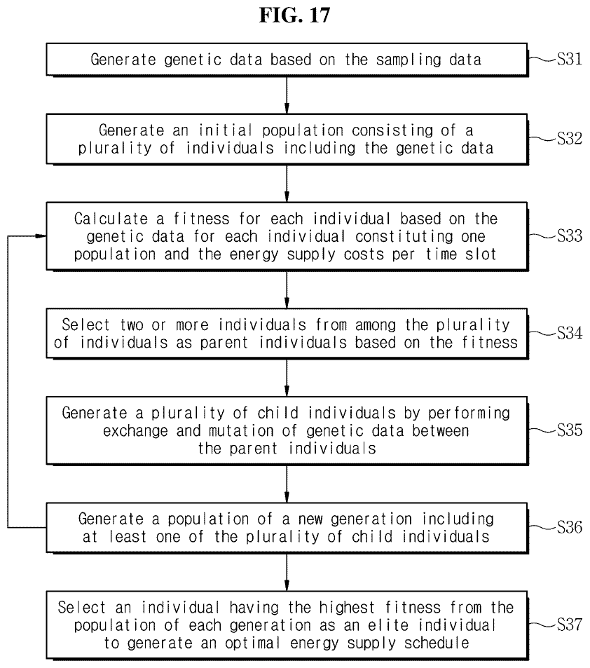

FIG. 17 is a flowchart illustrating an optimal energy supply scheduling step of a method for scheduling unused energy supply according to an embodiment.

Referring to FIG. 17, in relation to step S30 of generating the optimal energy supply schedule, first, in step S31, the supply scheduling apparatus generates genetic data based on the sampling data.

Here, the genetic data may include unused energy storage status information per time slot (es_status[t]), an unused energy supply ratio per time slot for each facility (s_factors[i,t]), and an unused energy supply amount per time slot for each facility (supply[i,t]).

Specifically, the unused energy storage status information per time slot (es_status[t]) represents a storage state of unused energy stored in an energy storage system (ESS) of a plant factory. An initial value of the unused energy storage status information per time slot (es_status[t]^{initial}) may be generated based on the predicted unused energy supply per time slot generated by the prediction model.

In particular, the initial value of the unused energy storage status information per time slot (es_status[t]^{initial}) may reflect a final value of the unused energy storage status information of a previous time slot (es_status[t−1]^{final}). In this case, the final value of the unused energy storage status information per time slot (es_status[t]^{final}) may be set as a value obtained by subtracting the unused energy supply amount per time slot for each facility (supply[i,t]) from the initial value of the unused energy storage status information per time slot (es_status[t]^{initial}).

That is, the unused energy storage status information per time slot (es_status[t]) may continuously reflect the unused energy storage status information of the previous time slot (es_status[t−1]), thereby allowing for the continuous management of the storage state of the unused energy.

The unused energy supply amount per time slot for each facility (supply[i,t]) refers to the amount of unused energy supplied to each facility, and can be represented as a product of the initial value of the unused energy storage status information per time slot (es_status[t]^{initial}) and the unused energy supply ratio per time slot for each facility (s_factors[i,t]).

In this case, for an initial population, the unused energy supply ratio per time slot for each facility (s_factors[i,t]) may be randomly set within a range where the total sum is 100% or less. For populations of new generations after the initial population, the unused energy supply ratio per time slot for each facility (s_factors[i,t]) may be set through crossover and mutation.

Next, in step S32, the supply scheduling apparatus generates an initial population formed of a plurality of individuals including the genetic data.

The supply scheduling apparatus may set a population size representing the number of individuals constituting a population of one generation. For example, the supply scheduling apparatus may set the population size to a range of 20 to 100, and preferably to 50.

Next, in step S33, the supply scheduling apparatus calculates a fitness for each individual based on the genetic data for each individual constituting one population and the energy supply costs per time slot.

Here, the fitness serves as a criterion for evaluating the performance of an individual and may determine a search direction in the process of the genetic algorithm finding an optimal solution. For example, the supply scheduling apparatus may calculate the fitness in a search direction that reduces the supply price of unused energy, ensures the energy supply pattern follows the energy consumption pattern, and encourages a higher supply during time slots when the supply price of unused energy is low.

Specifically, the supply scheduling apparatus may calculate the fitness by reflecting, as evaluation functions for a preset period: a supply cost function (f_{B}); an unused energy final residual function (f_{R}); an unused energy reduction rate function (f_{UE}); a distance similarity function (f_{DS}) between the energy supply costs per time slot and the predicted unused energy supply per time slot; a directional similarity function (f_{PS}) between the energy supply costs per time slot and the predicted unused energy supply per time slot; and an unused energy supply-price efficiency function (f_{TE}).

The supply scheduling apparatus may set a weight for each evaluation function and calculate the fitness by summing the products of each evaluation function and its weight as shown in Equation 1 below.

$$S = \sum {f}_{i} \cdot {A}_{i} \qquad [ Equation 1 ]$$

$${f}_{i} = [ {f}_{B} , {f}_{R} , {f}_{PS} , {f}_{DS} , {f}_{TE} , {f}_{UE} ]$$

$${A}_{i} = [ {A}_{B} , {A}_{R} , {A}_{PS} , {A}_{DS} , {A}_{TE} , {A}_{UE} ]$$

Here, S represents the fitness, fᵢ represents an evaluation function, and Aᵢ represents a weight for the evaluation function.

Next, in step S34, the supply scheduling apparatus selects two or more individuals from among the plurality of individuals as parent individuals based on the fitness. Specifically, the supply scheduling apparatus may select the parent individuals using a roulette wheel selection method, in which an individual with a higher fitness has a higher probability of being selected.

Next, in step S35, the supply scheduling apparatus generates a plurality of child individuals by performing exchange and mutation of genetic data between the parent individuals.

Specifically, the supply scheduling apparatus may randomly exchange the unused energy supply ratio per time slot for each facility (s_factors[i,t]) between the parent individuals according to a preset crossover probability. For example, the supply scheduling apparatus may generate a random number between 0 and 1; it may perform the crossover if the random number is greater than or equal to the preset crossover probability, and may not perform the crossover if the random number is less than the crossover probability.

Additionally, the supply scheduling apparatus may randomly change the unused energy supply ratio per time slot for each facility (s_factors[i,t]) of some of the individuals subjected to exchange, according to a preset mutation probability. In particular, the supply scheduling apparatus may provide a new search space by performing mutation on the unused energy supply ratio per time slot for each facility (s_factors[i,t]). For example, the supply scheduling apparatus may generate a random number between 0 and 1; it may perform the mutation if the random number is greater than or equal to a preset mutation probability, and may not perform the mutation if the random number is less than the mutation probability. At this time, the supply scheduling apparatus may perform correction such that the total sum of the unused energy supply ratios per time slot for each facility (s_factors[i,t]) is 100% or less.

Next, in step S36, the supply scheduling apparatus generates a population of a new generation including at least one of the plurality of child individuals.

Specifically, the supply scheduling apparatus may generate the population of the new generation including at least one of the child individuals generated through crossover and mutation. For example, the supply scheduling apparatus may generate the population of the new generation through any one of a total replacement method, a partial replacement method, or an elite replacement method, depending on the purpose.

Also, the supply scheduling apparatus may generate populations of several generations by determining a generation size variable. The supply scheduling apparatus may freely select the generation size variable; for example, it may set the generation size variable to 100.

Finally, in step S37, the supply scheduling apparatus selects an individual having the highest fitness from the population of each generation as an elite individual to generate an optimal energy supply schedule.

The embodiments disclosed herein are provided merely as specific examples to facilitate understanding and are not intended to limit the scope of the present disclosure. It will be apparent to those skilled in the art that other modifications based on the present disclosure can be implemented in addition to the embodiments disclosed herein.

1. An apparatus for scheduling an unused energy supply to a plant factory, comprising:
a genetic data generation processor configured to generate genetic data based on sampling data including, for a preset period, a predicted energy demand per time slot for each facility of the plant factory and a predicted unused energy supply per time slot for each unused energy source;
a population generation processor configured to generate an initial population formed of a plurality of individuals including the genetic data, and a population of a new generation including at least one of a plurality of child individuals;
a fitness calculation processor configured to calculate a fitness for each individual based on the genetic data for each individual constituting one population and energy supply costs per time slot;
a parent individual selection processor configured to select two or more individuals from among the plurality of individuals as parent individuals based on the fitness;
a crossover/mutation processor configured to generate the plurality of child individuals by performing exchange and mutation of the genetic data between the parent individuals; and
an energy supply scheduling processor configured to generate an optimal energy supply schedule by selecting an individual having the highest fitness from the population of each generation as an elite individual,
wherein the genetic data generation processor is configured to generate the genetic data including unused energy storage status information per time slot (es_status[t]), an unused energy supply ratio per time slot for each facility (s_factors [i,t]), and an unused energy supply amount per time slot for each facility (supply[i,t]),
wherein an initial value of the unused energy storage status information per time slot (es_status[t]^{initial}) is generated as a sum of the predicted unused energy supply per time slot (supply[i,t]) and a final value of the unused energy storage status information of a previous time slot (es_status[t−1]^{final}), and wherein the crossover/mutation processor is configured to:
randomly exchange the unused energy supply ratio per time slot for each facility (s_factors[i,t]) between the parent individuals according to a preset crossover probability, and
randomly change the unused energy supply ratio per time slot for each facility (s_factors[i,t]) of some of the individuals subjected to the exchange, according to a preset mutation probability.

2. (canceled)

3. (canceled)

4. (canceled)

5. The apparatus of claim 1, wherein the unused energy supply amount per time slot for each facility (supply[i,t]) is a product of the initial value of the unused energy storage status information per time slot (es_status[t]^{initial}) and the unused energy supply ratio per time slot for each facility (s_factors[i,t]).

6. The apparatus of claim 5, wherein for the initial population, the unused energy supply ratio per time slot for each facility (s_factors[i,t]) is randomly set.

7. The apparatus of claim 6, wherein the fitness calculation processor is configured to calculate the fitness through Equation 1 below by reflecting, as evaluation functions for the preset period:
an unused energy supply cost function (f_{B});
an unused energy final residual function (f_{R});
an unused energy reduction rate function (f_{UE});
a distance similarity function (f_{DS}) between the energy supply costs per time slot and the predicted unused energy supply per time slot;
a directional similarity function (f_{PS}) between the energy supply costs per time slot and the predicted unused energy supply per time slot; and
an unused energy supply-price efficiency function (f_{TE}),
$$S = \sum {f}_{i} \cdot {A}_{i} \qquad [ Equation 1 ]$$
$${f}_{i} = [ {f}_{B} , {f}_{R} , {f}_{PS} , {f}_{DS} , {f}_{TE} , {f}_{UE} ]$$
$${A}_{i} = [ {A}_{B} , {A}_{R} , {A}_{PS} , {A}_{DS} , {A}_{TE} , {A}_{UE} ]$$
where S represents the fitness, fᵢ represents an evaluation function, and Aᵢ represents a weight for the evaluation function.

8. The apparatus of claim 1, wherein the parent individual selection processor is configured to select the parent individuals using a roulette wheel selection method, in which an individual with a higher fitness has a higher probability of being selected.

9. (canceled)

10. (canceled)

11. (canceled)

12. A method for scheduling an unused energy supply to a plant factory, performed by a supply scheduling apparatus, the method comprising:
generating genetic data based on sampling data including, for a preset period, a predicted energy demand per time slot for each facility of the plant factory and a predicted unused energy supply per time slot for each unused energy source;
generating an initial population formed of a plurality of individuals including the genetic data;
calculating a fitness for each individual based on the genetic data for each individual constituting one population and energy supply costs per time slot;
selecting two or more individuals from among the plurality of individuals as parent individuals based on the fitness;
generating a plurality of child individuals by performing exchange and mutation of the genetic data between the parent individuals;
generating a population of a new generation including at least one of the plurality of child individuals; and
generating an optimal energy supply schedule by selecting an individual having the highest fitness from the population of each generation as an elite individual,
wherein generating genetic data includes generating the genetic data including unused energy storage status information per time slot (es_status[t]), an unused energy supply ratio per time slot for each facility (s_factors[i,t]), and an unused energy supply amount per time slot for each facility (supply[i,t]),
wherein an initial value of the unused energy storage status information per time slot (es_status[t]^{initial}) is generated as a sum of the predicted unused energy supply per time slot (supply[i,t]) and a final value of the unused energy storage status information of a previous time slot (es_status[t−1]^{final}), and
wherein generating a plurality of child individuals includes:
randomly exchanging the unused energy supply ratio per time slot for each facility (s_factors[i,t]) between the parent individuals according to a preset crossover probability, and
randomly changing the unused energy supply ratio per time slot for e ach facility (s_factors[i,t]) of some of the individuals subjected to the exchange, according to a preset mutation probability.

13. (canceled)
